(19) United States
(12) Patent Application Publication
(10) Pub. No.: US 2026/0242884 A1
(43) Pub. Date: Aug. 20, 2026

(54) MOLTEN STEEL MANUFACTURING METHOD AND ARC FURNACE

(71) Applicant: NIPPON STEEL CORPORATION, Tokyo (JP)

(72) Inventors: Yuichi TSURUKAWA, Tokyo (JP); Tsuyoshi YAMAZAKI, Tokyo (JP); Norifumi ASAHARA, Tokyo (JP); Yohsuke MASAKI, Tokyo (JP); Naoto SASAKI, Tokyo (JP); Masaki MIYATA, Tokyo (JP); Akihide KAIZAWA, Tokyo (JP); Shuhei KASAHARA, Tokyo (JP)

(73) Assignee: NIPPON STEEL CORPORATION, Tokyo (JP)

(21) Appl. No.: 19/162,075

(22) PCT Filed: Mar. 15, 2024
(86) PCT No.: PCT/JP2024/010322

§ 371 Date: Sep. 4, 2025

(30) Foreign Application Priority Data
Mar. 16, 2023 (JP) 2023-042074
Nov. 2, 2023 (JP) 2023-188753

(51) Int. Cl. C21C 5/52; C21C 7/00; F27B 3/22; F27D 3/16

(52) U.S. Cl. CPC C21C 5/5217; C21C 7/0025; C21C 7/0037; F27B 3/225; F27D 3/16; F27D 2003/164

(57) ABSTRACT

A manufacturing method for molten steel using an arc furnace comprising an oxygen supplier and an auxiliary raw material supplier includes: injecting an oxygen jet stream from the oxygen supplier to molten iron within the arc furnace; and supplying an auxiliary raw material from the auxiliary raw material supplier toward a position P on a surface of the molten iron, wherein the position P is a position outside an impingement surface between the oxygen jet stream and the molten iron.

### FIELD

The present application discloses a method for manufacturing molten steel using an arc furnace and the arc furnace.

### BACKGROUND

PTL 1 discloses a technique in which an immersion lance is immersed in molten iron within an arc furnace, a carbon material is blown from the immersion lance, and oxygen is blown into slag generated on the surface of the molten iron. In PTL 1, carbon concentration in molten iron is increased in an arc furnace, the molten iron is then tapped from the arc furnace, followed by refining in a converter, to manufacture molten steel. During refinement in the converter, for example, CO gas is generated by a decarburization reaction using an oxygen jet stream, and the CO gas promotes denitrification.

The above denitrification can also occur in an arc furnace. It is considered that, for example, by supplying oxygen and a carbon material simultaneously with respect to molten iron within an arc furnace, the above denitrification is possible. However, at present, denitrification within an arc furnace has not been sufficiently examined. Note that in an arc furnace, oxygen and a carbon material are sometimes blown simultaneously, mainly for the purpose of promoting slag foaming. In this case, it is common to merge the carbon material into the oxygen jet stream and concentratedly supply carbon and oxygen to a single site of the molten iron, thereby reliably generating CO gas in the slag and stabilizing a foaming state of the slag.

Oxygen and an auxiliary raw material other than a carbon material can also be supplied simultaneously with respect to the molten iron within the arc furnace. Auxiliary raw materials other than a carbon material include Ca-containing materials (such as lime), Si-containing materials (such as quartz sand), Al-containing materials (such as calcium aluminate), and Mg-containing materials (such as magnesia).

### CITATION LIST

### Patent Literature

[PTL 1] Japanese Unexamined Patent Publication No. 2016-145393

### SUMMARY

### Technical Problem

According to the findings of the present inventors, when an auxiliary raw material is supplied so as to be entrained with an oxygen jet stream with respect to molten iron within an arc furnace, efficiency of the intended reaction is likely to decrease. For example, when denitrifying molten iron within an arc furnace, if a carbon material is merged into an oxygen jet stream, and carbon and oxygen are concentratedly supplied to a single site of the molten iron, sufficient denitrification efficiency cannot be obtained.

### Solution to Problem

The present application discloses, as one of the means for achieving the above object, the following plurality of embodiments.

### Aspect 1

A manufacturing method for molten steel using an arc furnace comprising an oxygen supplying means and an auxiliary raw material supplying means, the method comprising injecting an oxygen jet stream from the oxygen supplying means to molten iron within the arc furnace; and supplying an auxiliary raw material from the auxiliary raw material supplying means toward a position P on a surface of the molten iron, wherein the position P is a position outside an impingement surface between the oxygen jet stream and the molten iron.

### Aspect 2

The manufacturing method for molten steel according to Aspect 1, wherein the auxiliary raw material is a carbon material.

### Aspect 3

The manufacturing method for molten steel according to Aspect 1 or 2, wherein a relation (1) below is satisfied:

$$r \leq 0.7 \times {W}_{m}^{\frac{1}{3}} \qquad ( 1 )$$

wherein
r is a distance (m) from an intersection O of a central axis of the oxygen jet stream and a surface of the molten iron to the position P, and
Wₘ is a weight (t) of the molten iron.

### Aspect 4

The manufacturing method for molten steel according to any of Aspects 1 to 3, the method comprising
injecting the oxygen jet stream from the oxygen supplying means to molten iron within the arc furnace; and supplying a carbon material from a carbon material supplying means as the auxiliary raw material supplying means toward a position P₁, wherein
a direction of the oxygen jet stream is tilted with respect to a vertical direction,
the position P₁ is on a horizontal surface including a static molten iron surface,
the position P₁ is outside the impingement surface between the oxygen jet stream and the molten iron,
a perpendicular line dropped from a tip of the oxygen supplying means to the horizontal surface intersects with the horizontal surface at an intersection P₂,
a central axis of the oxygen jet stream intersects with the horizontal surface at an intersection P₃, and
an angle θ₁ between a line segment P₁P₃ connecting the position P₁ to the intersection P₃ and a line segment P₂P₃ connecting the intersection P₂ to the intersection P₃ is 0° or more and 90° or less.

### Aspect 5

The manufacturing method for molten steel according to Aspect 4, wherein
on the horizontal surface, when a semicircle having a radius 3r₁ (r₁: minor radius of geometrical hot spot) centered on the intersection P₃ and having the line segment P₂P₃ as an axis of symmetry is assumed, the position P₁ is inside the semicircle.

### Aspect 6

An arc furnace for processing molten iron, comprising at least one oxygen supplying means and at least one auxiliary raw material supplying means, wherein
the oxygen supplying means is configured to inject an oxygen jet stream toward a surface of the molten iron within the arc furnace, and
the auxiliary raw material supplying means is configured to supply an auxiliary raw material toward a position P on a surface of the molten iron within the arc furnace, and is configured so that the position P is positioned outside an impingement surface between the oxygen jet stream and the molten iron.

### Aspect 7

The arc furnace according to Aspect 6, wherein
the auxiliary raw material supplying means comprises at least one carbon material supplying means,
the oxygen supplying means is configured so that a direction of the oxygen jet stream is tilted with respect to a vertical direction,
the carbon material supplying means is configured to supply a carbon material toward a position P₁, and
the oxygen supplying means and the carbon material supplying means are configured so that:
   the position P₁ is on a horizontal surface including a static molten iron surface;
   the position P₁ is outside the impingement surface between the oxygen jet stream and the horizontal surface;
   a perpendicular line dropped from a tip of the oxygen supplying means to the horizontal surface intersects with the horizontal surface at an intersection P₂;
   a central axis of the oxygen jet stream intersects with the horizontal surface at an intersection P₃; and
   an angle θ₁ between a line segment P₁P₃ connecting the position P₁ to the intersection P₃ and a line segment P₂P₃ connecting the intersection P₂ to the intersection P₃ is 0° or more and 90° or less.

### Effects of Invention

According to the manufacturing method for molten steel and the arc furnace of the present disclosure, when an oxygen jet stream is injected and an auxiliary raw material is supplied with respect to molten iron within an arc furnace, the intended reaction can be efficiently produced. For example, when an oxygen jet stream is injected and a carbon material as an auxiliary raw material is supplied with respect to molten iron, the molten iron can be efficiently denitrified.

### BRIEF DESCRIPTION OF DRAWINGS

FIG. 1 schematically shows one example of the positional relationship of each member when the arc furnace is viewed from above.

FIG. 2A schematically shows one example of the positional relationship of the oxygen supplying means and the auxiliary raw material supplying means when the arc furnace is viewed from the side thereof. The upper electrode, etc. are omitted.

FIG. 2B schematically shows one example of the positional relationship of the oxygen supplying means and the auxiliary raw material supplying means when the arc furnace is viewed from the side thereof. The upper electrode, etc. are omitted.

FIG. 3 schematically shows one example of the positional relationship of the oxygen jet stream and the auxiliary raw material supplying position.

FIG. 4 schematically shows one example of the positional relationship between the position P₁, the intersection P₂, and the intersection P₃ on the horizontal surface including a static molten iron surface, when the arc furnace is viewed from above.

FIG. 5 schematically shows one example of the positional relationship between the oxygen supplying means and the carbon material supplying means when the arc furnace is viewed from the side thereof. The upper electrode, etc. are omitted.

FIG. 6 schematically shows one example of the shape of the oxygen jet stream and the shape of the impingement surface between the horizontal surface including a static molten iron surface and the oxygen jet stream.

FIG. 7 schematically shows one example of the direction of flow induced around the impingement surface of the oxygen jet stream.

FIG. 8 schematically shows one example of a preferable position for the position P₁ on the horizontal surface including a static molten iron surface.

### DESCRIPTION OF EMBODIMENTS

### 1. Manufacturing Method for Molten Steel

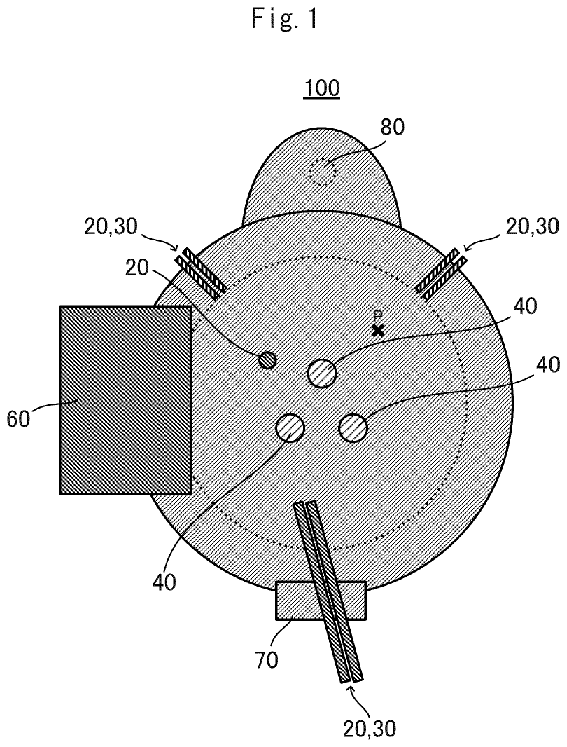

The manufacturing method for molten steel of the present disclosure will be described with reference to the drawings. However, the manufacturing method for molten steel of the present disclosure is not limited to the embodiments illustrated. As shown in FIGS. 1 to 3, the manufacturing method for molten steel according to one embodiment is a method for manufacturing molten steel using an arc furnace 100 comprising an oxygen supplying means 20 and an auxiliary raw material supplying means 30, comprising injecting an oxygen jet stream 21 from the oxygen supplying means 20 to molten iron 10 within the arc furnace 100; and supplying an auxiliary raw material 31 from the auxiliary raw material supplying means 30 toward a position P on a surface of the molten iron 10. The position P is a position outside an impingement surface 21x between the oxygen jet stream 21 and the molten iron 10.

### 1.1 Molten Iron

The molten iron 10 can be obtained by, for example, generating an arc in the arc furnace 100 to melt an iron source. The iron source, for example, may comprise at least one selected from solid iron sources such as scrap, reduced iron, pig iron, and powdered iron, or molten iron or molten steel manufactured in another melting furnace or refining furnace may be used therefor. The molten iron 10 can comprise various elements other than iron. The composition of elements other than iron depends on the type of iron source. For example, molten iron 10 before supplying an auxiliary raw material 31 may comprise 0.02% by mass or greater and 3.0% by mass or less of C, may comprise 0.005% by mass or greater and 0.030% by mass or less of N, and may comprise 0.003% by mass or greater and 0.1% by mass or less of P. Particularly, in the manufacturing method of the present disclosure, when an oxygen jet stream 21 is injected to produce decarburization and denitrification reactions while supplying a carbon material as an auxiliary raw material 31 to the molten iron 10, a more notable effect can be obtained in a low carbon range, where solute carbon transport in the molten iron 10 limits the rate of the decarburization reaction. In the manufacturing method of the present disclosure, when supplying a carbon material as an auxiliary raw material 31 to the molten iron 10, the molten iron 10 before supplying the auxiliary raw material 31 may comprise 0.02% by mass or greater and 3.0% by mass or less of C, may comprise 0.005% by mass or greater and 0.030% by mass or less of N, and may comprise 0.003% by mass or greater and 0.1% by mass or less of P. Alternatively, in the manufacturing method of the present disclosure, when supplying an auxiliary raw material other than a carbon material as the auxiliary raw material 31 to the molten iron 10, it is preferable that supplying in an ultra-low carbon concentration range, where the carburization reaction becomes difficult in terms of equilibrium theory, be avoided. For example, the molten iron 10 before supplying an auxiliary raw material 31 preferably comprises 0.3% by mass or greater of C. More specifically, in the manufacturing method of the present disclosure, when supplying an auxiliary raw material other than a carbon material as the auxiliary raw material 31 to the molten iron 10, the molten iron 10 before supplying the auxiliary raw material 31 may comprise 0.3% by mass or greater and 3.0% by mass or less of C, may comprise 0.010% by mass or greater and 0.030% by mass or less of N, and may comprise 0.003% by mass or greater and 0.1% by mass or less of P. The density of the molten iron 10 may be, for example, 6600 kg/m³ or more and 7000 kg/m³ or less.

### 1.2 Oxygen Supplying Means

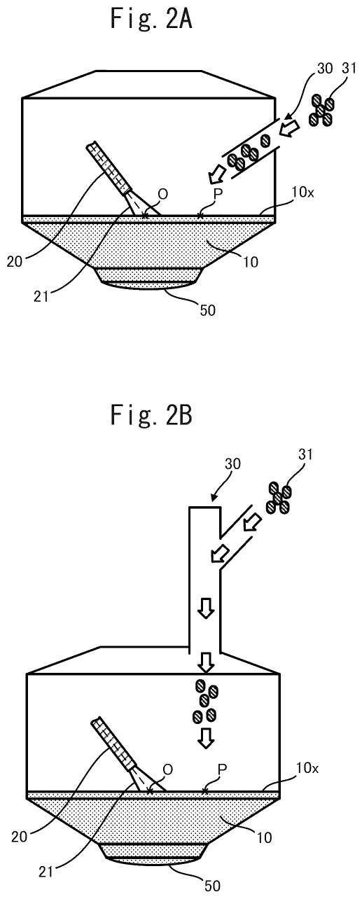

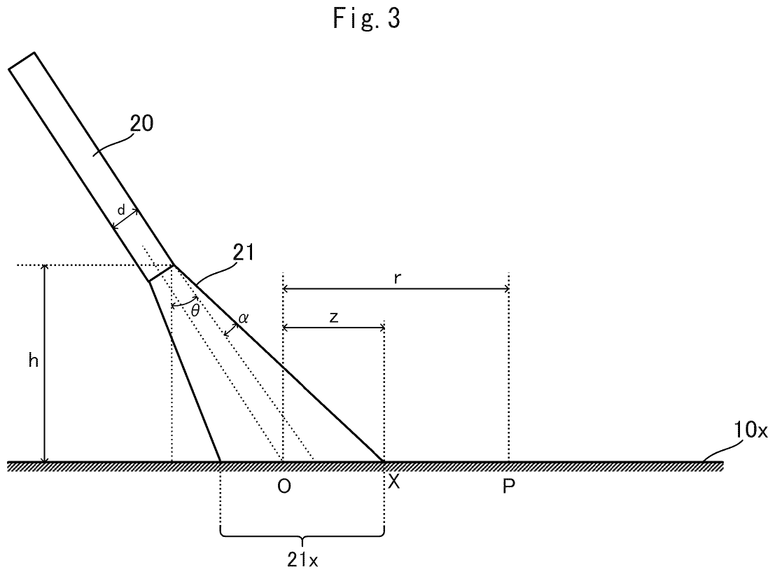

The arc furnace 100 comprises at least one oxygen supplying means 20. The oxygen supplying means 20 injects an oxygen jet stream 21 to molten iron 10 within an arc furnace 100. The oxygen supplying means 20 may be a lance. The number of oxygen jet streams 21 injected from one lance is not particularly limited. For example, the lance may be a single-hole lance as shown in FIGS. 2 and 3. In addition, the lance may have a straight shape, may have a laval structure, or may comprise a coherent burner in which a gaseous fuel and a combustion-supporting gas are injected so as to surround the oxygen jet stream. As shown in FIG. 1, the oxygen supplying means 20 may be at least one of a lance (so-called main lance) inserted from a furnace cover of the arc furnace 100, a wall lance provided on a furnace wall, and a variable lance whose position is determined by a manipulator. As shown in FIGS. 2 and 3, in the arc furnace 100, oxygen is top-blown from the oxygen supplying means 20 toward a surface 10x of the molten iron 10. As a result, depending on the type of auxiliary raw material 31 described below, various chemical reactions such as decarburization reaction, denitrification reaction, and dephosphorization reaction can be produced in the molten iron 10.

The shape of the oxygen jet stream 21 injected from the oxygen supplying means 20 depends on the tilt of the oxygen supplying means 20 and the shape of the injection hole of the oxygen supplying means 20. The direction of the oxygen jet stream 21 injected from the oxygen supplying means 20 may be tilted with respect to the vertical direction. Specifically, as shown in FIG. 3, the direction of the oxygen jet stream 21 injected from the oxygen supplying means 20 may be tilted at an angle θ with respect to the vertical direction. The tilting angle θ can be specified as an angle between a central axis of the oxygen supplying means 20 and a line parallel to the vertical direction. The tilting angle θ may be, for example, 5° or more and 30° or less. In addition, as shown in FIG. 3, the oxygen jet stream 21 may be injected from an injection hole of the oxygen supplying means 20 at a certain spread angle α to the molten iron 10. The spread angle α depends on the shape of the injection hole of the oxygen supplying means 20. The spread angle α may be, for example, 10° or more and 13° or less. Further, as shown in FIG. 3, a certain height h from the injection hole of the oxygen supplying means 20 to the surface 10x of the molten iron 10 may be set. When the oxygen supplying means 20 is tilted with respect to the vertical direction, the height h refers to a distance from the upper end of the injection hole of the oxygen supplying means 20 to the surface 10x of the molten iron 10. The height h may be, for example, 0.2 m or more and 0.8 m or less. Moreover, as shown in FIG. 3, the oxygen supplying means 20 may have an injection hole with a hole diameter d. The hole diameter d refers to a circle-equivalent diameter of the injection hole. The hole diameter d may be, for example, 20 mm or more and 100 mm or less.

The flow rate of the oxygen jet stream 21 injected from one oxygen supplying means 20 is not particularly limited, and may be, for example, 1000 Nm³/h or more and 4000 Nm³/h or less. The flow velocity (flow velocity at the central axis, which is the flow velocity at the injection hole of the oxygen supplying means 20) of the oxygen jet stream 21 injected from the oxygen supplying means 20 is not particularly limited, and may be, for example, 10 m/s or more and 3000 m/s or less.

### 1.3 Auxiliary Raw Material Supplying Means

The arc furnace 100 comprises at least one auxiliary raw material supplying means 30. The auxiliary raw material supplying means 30 supplies an auxiliary raw material toward a position P on the surface of the molten iron 10 within the arc furnace 100. The auxiliary raw material can be supplied to the furnace interior via, for example, a supply port provided on the arc furnace 100. The supply port may be provided on any portion of the furnace. For example, the supply port may be a hole provided on a furnace interior wall (side wall), or may be a hole provided on the furnace cover. As shown in FIG. 3, the supply port can be installed above the surface 10x of the molten iron 10. The number of supply ports may be one, or may be greater than one.

The auxiliary raw material supplying method by the auxiliary raw material supplying means 30 is not particularly limited. Examples include a method of supplying an auxiliary raw material 31 via a hole provided in a furnace interior wall as shown in FIG. 2(A) and a method of supplying an auxiliary raw material 31 via a hole provided in a furnace cover as shown in FIG. 2(B). According to the positional relationship between the hole provided in the furnace interior wall or furnace cover and the supplying position P of the auxiliary raw material 31 on the surface 10x of the molten iron 10, appropriately, a lance or a charging chute may be adopted. Any known charging chute may be used. When a lance is adopted as the auxiliary raw material supplying means 30, the auxiliary raw material 31 may be supplied with a top-blowing gas to the molten iron 10. In this case, for the top-blowing gas from the auxiliary raw material supplying means 30, one that does not generate a hot spot on the surface of the molten iron 10 may be adopted, or one that generates a hot spot may be adopted. For example, from the viewpoint of cost, it is preferable that one or both of air and N₂ gas be used; from the viewpoint of decreasing nitrogen, it is preferable that at least one selected from pure oxygen, Ar gas, and CO₂ gas be used; and when the auxiliary raw material is a carbon material or a deoxidizing material, to avoid being consumed in the air before reaching the iron bath, it is preferable that one or both of Ar gas and CO₂ gas, which have a lower reactivity, be used. As such, the top-blowing gas may be selected according to manufacturing conditions, and may be a mixture of at least two gases in a predetermined ratio within the ranges of these operational constraints. The lance as an oxygen supplying means 20 and the lance as an auxiliary raw material supplying means 30 above are separate from each other.

The auxiliary raw material 31, with respect to the molten iron 10, may be supplied in a vertically downward direction, or may be supplied in an obliquely downward direction. In either case, the auxiliary raw material supplying means 30 supplies an auxiliary raw material toward a predetermined position P. The description “toward a position P” means that the target position where an auxiliary raw material 31 is supplied is position P, and a portion of the auxiliary raw material 31 may be supplied to a portion other than the position P by dispersion. For example, a portion of the auxiliary raw material 31 may be supplied to the inner side of an impingement surface 21x between the oxygen jet stream 21 and the molten iron 10. In the manufacturing method of the present disclosure, a large portion of the auxiliary raw material 31, for example, 50% by mass or greater, 70% by mass or greater, or 90% by mass or greater, is preferably supplied to a position P outside an impingement surface 21x between the oxygen jet stream 21 and the molten iron 10.

The amount of auxiliary raw material 31 supplied from the auxiliary raw material supplying means 30 is not particularly limited. For example, the amount of auxiliary raw material 31 supplied from one auxiliary raw material supplying means 30 may be 10 kg/min or more and 100 kg/min or less.

The type of auxiliary raw material 31 supplied by the auxiliary raw material supplying means 30 is not particularly limited. The auxiliary raw material 31, for example, may be a carbon material, or may be an auxiliary raw material other than a carbon material. Specific examples of carbon materials are described below. The auxiliary raw material other than a carbon material may be at least one selected from Ca-containing materials (such as lime), Si-containing materials (such as quartz sand), Al-containing materials (such as calcium aluminate), and Mg-containing materials (such as magnesia). The shape of the auxiliary raw material 31 needs only to be a shape that allows the material to be appropriately supplied from the auxiliary raw material supplying means 30 to the molten iron 10, and may be in various shapes such as powder form, granular form, and lump form. In addition, the auxiliary raw material 31 may be a pressure-molded product. Further, a plurality of auxiliary raw materials 31 may be mixed. The auxiliary raw material 31 may have a particle size of, for example, 0.1 mm or more and 5 mm or less. When the auxiliary raw material 31 is large, in addition to the powder transport system provided in general steelmaking equipment being easily clogged, heat transfer properties can deteriorate due to a smaller specific surface area, causing the material to remain unmelted on the molten iron 10 for a longer period of time. When the auxiliary raw material 31 is small, scatterability within the furnace increases and the material is likely to be drawn into the exhaust gas system, resulting in poor yield.

In the manufacturing method of the present disclosure, by supplying the auxiliary raw material 31 toward a predetermined position P outside a hot spot, the auxiliary raw material 31 supplied to the hot spot is decreased and a decrease in temperature at the hot spot can be suppressed. As a result, the intended reaction can be efficiently produced. In addition, in the manufacturing method of the present disclosure, when the auxiliary raw material 31 is a carbon material, a decrease in yield due to combustion of the carbon material in the oxygen jet stream 21 is suppressed, and further, by supplying the carbon material toward a predetermined position P outside the hot spot, carbon deposition rate onto the molten iron 10 can be improved, and denitrification efficiency can be notably improved.

### 1.4 Position P

As shown FIGS. 2 and 3, the position P is a position outside the impingement surface 21x between the oxygen jet stream 21 and the molten iron 10. Preferably, as shown in FIG. 2, the auxiliary raw material 31 is supplied to the position P without crossing the oxygen jet stream 21 (in other words, it is preferable that the oxygen jet stream 21 be absent along the path where the auxiliary raw material 31 reaches the molten iron 10 from the auxiliary raw material supplying means 30). The “impingement surface 21x between the oxygen jet stream 21 and the molten iron 10” can be specified geometrically from the tilting angle θ, spread angle α, height h, and hole diameter d described above. For example, as shown in FIG. 3, a distance z from the intersection O of the central axis of the oxygen supplying means 20 and the surface 10x of the molten iron 10 to an outer edge X of the impingement surface 21x can be specified as z=(tan(θ+α)−tan θ)h+d/(2 cos θ). As shown in FIG. 3, if a distance r from the intersection O of the central axis of the oxygen jet stream 21 and the surface 10x of the molten iron 10 to the position P is larger than the distance z, the position P can be outside the impingement surface 21x between the oxygen jet stream 21 and the molten iron 10. Specifically, in the manufacturing method of the present disclosure, the distance r from the intersection O of the central axis of the oxygen jet stream 21 and the surface 10x of the molten iron 10 to the position P may satisfy the relation r>(tan(θ+α)−tan θ)h+d/(2 cos θ).

As described above, the position P needs only to be a position outside the impingement surface 21x between the oxygen jet stream 21 and the molten iron 10, and the upper limit of the distance r is not particularly limited. However, in the manufacturing method of the present disclosure, by shortening the distance r relative to the characteristic length calculated based on the weight of the molten iron 10, it is considered that movement of the auxiliary raw material 31 to the hot spot is less likely to be delayed, leading to an increased concentration of the auxiliary raw material in the vicinity of the hot spot, and thereby the intended reaction can be more efficiently produced. Consider the case where the auxiliary raw material 31 is a carbon material. In this case, when decarburization of the molten iron 10 proceeds due to the oxygen jet stream 21, causing carbon concentration of the molten iron 10 to fall below the critical carbon concentration, consumption rate of carbon in the molten iron 10 by the decarburization reaction exceeds supplying rate of dissolved carbon to the reaction site. Thus, the ratio of oxygen supplied by the oxygen feed that contributes to decarburization (decarburizing oxygen efficiency) gradually decreases and CO generation rate at the hot spot decreases, which can result in a disadvantageous state for denitrification. There is also a risk that Fe in the molten iron 10 becomes excessively oxidized, resulting in a decrease in iron yield, or that FeO concentration in the slag increases, resulting in damage to the refractories of the arc furnace 100. By shortening the distance r relative to the characteristic length calculated based on the weight of the molten iron 10 and thereby increasing the dissolved carbon concentration in the vicinity of the hot spot, it is considered that activity of dissolved [N] increases, denitrification efficiency is further improved, and excessive oxidation of Fe is suppressed.

From the above viewpoint, the position P where the auxiliary raw material 31 is supplied may be determined with reference to the characteristic length of the iron bath determined from the weight of the molten iron 10 in each charge and the value of stirring power density. For example, according to publicly known literature such as “Asai et al.: Iron and Steel, 68(1982), vol. 3, pp. 426-434”, since the characteristic flow velocity in the inertial region of the fluid is proportional to the ⅓ power of the stirring power density, if the distance r from the intersection O to the position P is sufficiently short with respect to the characteristic flow velocity, the delay in the supply of the auxiliary raw material 31 to the hot spot is mitigated. For example, when the auxiliary raw material 31 is a carbon material, a high rate of CO gas generation due to the decarburization reaction is maintained, which is advantageous to denitrification. Specifically, for example, with respect to a furnace in which top-blowing stirring and bottom-blowing stirring are dominant, the upper limit of the distance r can be defined such that the following relation is satisfied.

$$r \leq \frac{{( L \dot{{ε}_{a}} )}^{\frac{1}{3}}}{1.8}$$

$$L = {( \frac{{W}_{m}}{{ρ}_{l}} )}^{\frac{1}{3}}$$

$$\dot{{ε}_{a}} = {ε}_{T} + {ε}_{B}$$

wherein L: characteristic length (m), εₐ: total stirring power density (W/ton), Wₘ: weight (t) of molten iron, ρ₁: density (t/m³) of molten iron, ε_{T}: top-blowing stirring power density (W/ton), and ε_{B}: bottom-blowing stirring power density.

For stirring power density, a value obtained by linearly summing those of top-blowing and bottom-blowing is adopted, with reference to, for example, publicly known literature such as “Kai et al.: Iron and Steel, 69(1983), vol. 2, pp. 228-237” and “Mori et al.: Iron and Steel, 67(1981), vol. 6, pp. 672-695”. The stirring application means is not limited to those using a gas supply, and needs only to be a means that allows the same treatment to be applied. The stirring power density of stirring methods having different positions and principles may not be a linear sum, and each may be treated as having an independent contribution rate.

According to the findings of the present inventors, in the manufacturing method of the present disclosure, by satisfying the following relation (1), movement of the auxiliary raw material 31 to the hot spot is less likely to be delayed, leading to an increased auxiliary raw material concentration in the vicinity of the hot spot, and thereby the intended reaction is more likely to be efficiently produced.

$$r \leq 0.7 \times {W}_{m}^{\frac{1}{3}} \qquad ( 1 )$$

wherein
r is a distance (m) from an intersection O of a central axis of the oxygen jet stream 21 and a surface 10x of the molten iron 10 to the above position P, and
Wₘ is a weight (t) of the molten iron 10.

### 1.5 Additional Configurations in Arc Furnace

The arc furnace 100, as described above, comprises a melting furnace for melting an iron source. The melting furnace is a part that can be defined by a furnace cover, a furnace interior wall, and a furnace bottom. The planar shape of the melting furnace preferably has a circular portion as shown in FIG. 1. The melting furnace may have a certain bath depth and a certain furnace diameter. The bath depth and furnace diameter of the melting furnace are not particularly limited.

FIG. 1 exemplifies, as a means of generating an arc, an alternating-current system using only upper electrodes 40. However, the means of generating an arc is not limited thereto, and may include a direct-current system using an upper electrode 40 and a lower electrode 50. When the arc furnace 100 consists of a direct-current system, the upper electrode 40 can be a negative electrode, and the lower electrode 50 a positive electrode. The upper electrode 40 is mounted so as to be inserted into the furnace through the furnace cover. In addition, the lower electrode 50 is mounted on the furnace bottom. The number of upper electrode 40 and lower electrode 50 are each at least one. The positions of the upper electrode 40 and the lower electrode 50 are not particularly limited. For example, when the molten surface shape in the melting furnace is substantially circular in top view (planar view), the center position of the circle may coincide with the central axis of one upper electrode 40 or one lower electrode 50. Alternatively, in top view, a plurality of upper electrodes 40 or a plurality of lower electrodes 50 may be arranged around the center position of the circle. In the arc furnace 100, for example, power is supplied from a power supply unit, which is not illustrated, to the upper electrode 40 and the lower electrode 50 to generate an arc between the upper electrode 40 and the lower electrode 50. Any general power supply unit may be adopted as long as power is supplied to the upper electrode 40 and the lower electrode 50. The power supplied from the power supply unit to the electrodes is not particularly limited as long as an arc can be generated between the electrodes.

As shown in FIG. 1, the arc furnace 100 may comprise an iron source charging means 60 for charging an iron source into the melting furnace. In addition, the arc furnace 100 may comprise a slag removal door 70 for removing slag generated on the surface of the molten iron 10. Further, the arc furnace 100 may comprise a taphole 80 for tapping molten iron 10 or molten steel. Any of these may be adopted as long as a known configuration is used.

The arc furnace 100 can comprise various control units. A control unit, for example, may control the supplying position P (alternatively, position P₁ described below) of the auxiliary raw material 31 supplied from the auxiliary raw material supplying means 30 to the molten iron 10, according to the position of the oxygen jet stream 21 injected from the oxygen supplying means 20 to the molten iron 10, alternatively, may control the position of the oxygen jet stream 21 injected from the oxygen supplying means 20 to the molten iron 10, according to the supplying position P (alternatively, position P₁ described below) of the auxiliary raw material 31 supplied from the auxiliary raw material supplying means 30 to the molten iron 10, and alternatively, may control both of the position of the oxygen jet stream 21 injected from the oxygen supplying means 20 to the molten iron 10 and the supplying position P (alternatively, position P₁ described below) of the auxiliary raw material 31 supplied from the auxiliary raw material supplying means 30 to the molten iron 10. The control unit needs only to be one capable of executing the above control, and can comprise a known configuration for enabling execution of the control. For example, the control unit may comprise a CPU, RAM, and ROM.

### 1.6 Molten Steel

The composition of the molten steel manufactured by the method of the present disclosure is not particularly limited. In the manufacturing method of the present disclosure, as described above, an oxygen jet stream 21 is injected and an auxiliary raw material 31 is supplied with respect to the molten iron 10. Depending on the type of auxiliary raw material 31, decarburization, denitrification, or dephosphorization of the molten iron 10 is possible. The molten steel manufactured by the method of the present disclosure, for example, may comprise 0.01% by mass or greater and 3.0% by mass or less of C, may comprise 0.002% by mass or greater and 0.030% by mass or less of N, and may comprise 0.003% by mass or greater and 0.1% by mass or less of P. The molten steel within the arc furnace 100, for example, can be tapped via the above taphole 80. The tapped molten steel may be further refined, and alternatively, may be subjected to continuous casting as-is.

### 1.7 Applied Embodiment

In manufacturing molten steel using the arc furnace 100, when supplying a carbon material as an auxiliary raw material 31 toward the surface 10x of the molten iron 10 within the arc furnace 100, the carbon material is preferably supplied as described below. Hereinafter, with reference to FIG. 1 and FIGS. 4 to 8, a preferable embodiment of the manufacturing method for molten steel in the case where a carbon material as an auxiliary raw material 31 is supplied will be described.

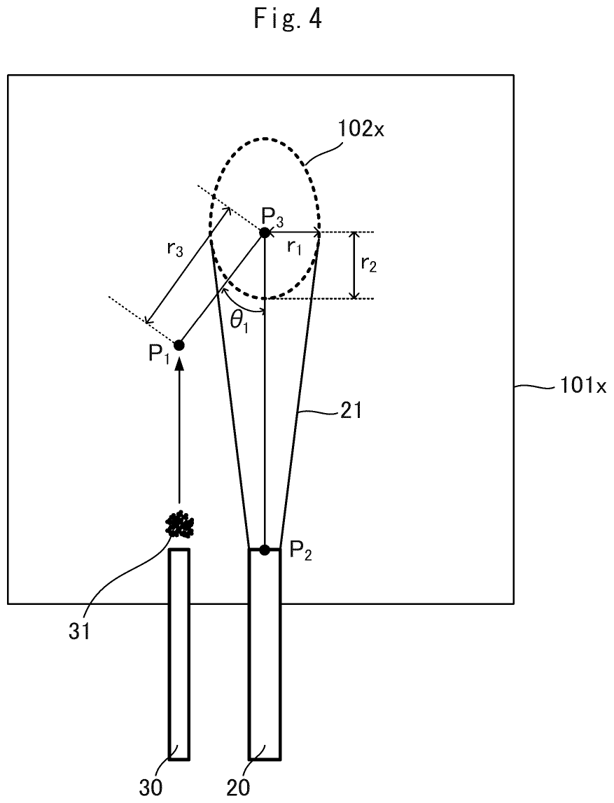

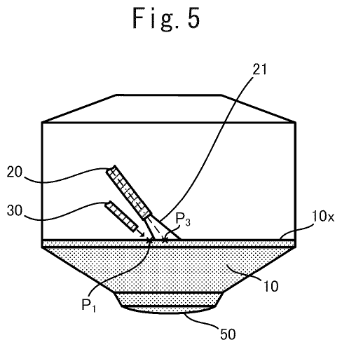

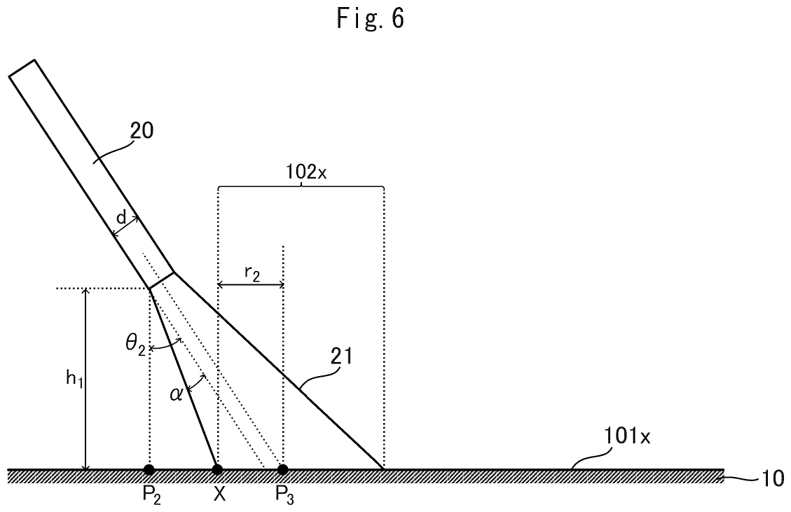

As shown in FIG. 1 and FIGS. 4 to 8, the manufacturing method for molten steel according to the applied embodiment comprises injecting an oxygen jet stream 21 from the oxygen supplying means 20 to molten iron within the arc furnace 100; and supplying a carbon material from a carbon material supplying means as the auxiliary raw material supplying means 30 toward a position P₁. As shown in FIGS. 5 and 6, the direction of the oxygen jet stream 21 is tilted with respect to the vertical direction. As shown in FIGS. 4 and 5, the position P₁ is on a horizontal surface 101x including a static molten iron surface. As shown in FIGS. 4 and 5, the position P₁ is outside an impingement surface 102x between the oxygen jet stream 21 and the horizontal surface 101x. As shown in FIGS. 4 and 6, a perpendicular line dropped from the tip of the oxygen supplying means 20 to the horizontal surface 101x intersects with the horizontal surface 101x at an intersection P₂. As shown in FIGS. 4 and 6, the central axis of the oxygen jet stream 21 intersects with the horizontal surface 101x at an intersection P₃. As shown in FIG. 4, an angle θ1 between a line segment P₁P₃ connecting the position P₁ and the intersection P₃ and a line segment P₂P₃ connecting the intersection P₂ and the intersection P₃ is 0° or more and 90° or less.

### 1.7.1 Molten Steel

The molten iron 10 is as described above. In the applied embodiment, a “horizontal surface 101x including a static molten iron surface” is assumed, and the positional relationship between the position P₁ and the impingement surface 102x on the horizontal surface 101x is specified. The “impingement surface 102x between oxygen jet stream 21 and horizontal surface 101x” can be said to be substantially the same as the above “impingement surface 21x between oxygen jet stream 21 and molten iron surface 10x” (refer to FIG. 3).

### 1.7.2 Oxygen Supplying Means

The function and type of the oxygen supplying means 20 are as described above. In the applied embodiment, the direction of the oxygen jet stream 21 injected from the oxygen supplying means 20 is tilted with respect to the vertical direction. For example, the direction of the oxygen jet stream 21 injected from the oxygen supplying means 20 may be tilted at an angle θ₂ with respect to the vertical direction. The tilting angle θ₂ can be specified as an angle between the central axis of the oxygen supplying means 20 and a line parallel to the vertical direction. The tilting angle θ₂ may be, for example, 5° or more and 85° or less, 15° or more and 75° or less, or 25° or more and 65° or less. Note that the preferred tilting angle θ₂ is considered to vary depending on the operating conditions of the arc furnace 100. The suitable tilting angle θ₂ is determined while also considering various reactions other than denitrification. In addition, as described above, the oxygen jet stream 21 may be injected from an injection hole of the oxygen supplying means 20 at a certain spread angle α to the molten iron 10. The spread angle α may be, for example, 10° or more and 13° or less. A height h₁ from the tip (which means “lower end of injection hole”; hereinafter, the same applies) of the oxygen supplying means 20 to the horizontal surface 10x may be set. The height h₁ may be, for example, 0.2 m or more and 1.5 m or less. Further, as described above, the oxygen supplying means 20 may have an injection hole with a hole diameter d. The hole diameter d may be, for example, 20 mm or more and 100 mm or less. The flow rate and flow velocity of the oxygen jet stream 21 injected from the oxygen supplying means 20 are as described above.

### 1.7.3 Carbon Material Supplying Means

In the applied embodiment, the arc furnace 100 comprises at least one carbon material supplying means as an auxiliary raw material supplying means 30. The carbon material supplying means supplies a carbon material as an auxiliary raw material 31 toward a position P₁ on a horizontal surface 101x within the arc furnace 100. The carbon material can be supplied to the furnace interior via, for example, a supply port provided on the arc furnace 100. As described above, the supply port may be provided on any portion of the furnace. For example, the supply port may be a hole provided on a furnace interior wall (side wall), or may be a hole provided on the furnace cover. The number of supply ports may be one, or may be greater than one.

The carbon material supplying method by the carbon material supplying means is not particularly limited, and for example, may be a method of supplying a carbon material via a hole provided in a furnace interior wall, or may be a method of supplying a carbon material via a hole provided in a furnace cover. According to the positional relationship between the hole provided in the furnace interior wall or furnace cover and the position P₁, appropriately, a lance or a charging chute may be adopted. Particularly, as shown in FIGS. 4 and 5, an embodiment in which the carbon material is sprayed using a lance is preferable. When the carbon material is sprayed using a lance, for example, supplying the carbon material toward the position P₁ where θ₁ described below is 0° is easy. In addition, by spraying the carbon material using a lance, it is considered that a flow from the position P₁ toward the impingement surface 102x can be induced. Any known charging chute may be adopted. When a lance as the carbon material supplying means is adopted, the carbon material can be supplied to the molten iron 10 with a carrier gas. In this case, for the carrier gas from the carbon material supplying means, one that is generally used in gas transport of a powder may be adopted. For example, from the viewpoint of cost, it is preferable that one or both of air and N₂ gas be used, and from the viewpoint of decreasing nitrogen, it is preferable that at least one selected from pure oxygen, Ar gas, and CO₂ gas be used. To prevent the carbon material from being consumed in the air before reaching the iron bath, it is preferable that one or both of Ar gas and CO₂ gas having a lower reactivity be used. As such, the carrier gas may be selected according to manufacturing conditions, and may be a mixture of at least two gases in a predetermined ratio within the ranges of these operational constraints. The lance as the oxygen supplying means 20 and the lance as an auxiliary raw material supplying means 30 are separate from each other. The lance as the carbon material supplying means may be at least one of a lance (so-called main lance) inserted from a furnace cover of the arc furnace 100, a wall lance provided on a furnace wall, and a variable lance whose position is determined by a manipulator. For the lance as the carbon material supplying means, the tip thereof may be located inside or outside the melting furnace of the arc furnace 100.

In the applied embodiment, the carbon material as the auxiliary raw material 31, with respect to the molten iron 10, may be supplied in a vertically downward direction, or may be supplied in an obliquely downward direction. In either case, the carbon material supplying means as the auxiliary raw material supplying means 30 supplies the carbon material toward a predetermined position P₁. The description “toward a position P₁” means that the target position where the carbon material is supplied is position P₁, and a portion of the carbon material may be supplied to a portion other than the position P₁ by dispersion. For example, a portion of the carbon material may be supplied to the inner side of an impingement surface 102x of the oxygen jet stream 21. In the applied embodiment, a large portion of the carbon material, for example, 50% by mass or greater, 70% by mass or greater, or 90% by mass or greater, is preferably supplied to a position P₁ outside the impingement surface 102x.

The amount of carbon material supplied from the carbon material supplying means is not particularly limited. For example, the amount of carbon material supplied from one carbon material supplying means may be 10 kg/min or more and 100 kg/min or less.

The shape of the carbon material needs only to be a shape that allows the material to be appropriately supplied from the carbon material supplying means to the molten iron 10, and may be in various shapes such as powder form, granular form, and lump form. As the carbon material, any carbon material such as bituminous coal, anthracite, powdered coke, pitch coke, or biomass-based carbon may be used. In addition, the carbon material may be a pressure-molded product. Further, a plurality of carbon materials may be mixed. The carbon material may have a particle size of, for example, 0.1 mm or more and 5 mm or less. When the carbon material is large, in addition to the powder transport system provided in general steelmaking equipment being easily clogged, heat transfer properties can deteriorate due to a smaller specific surface area, causing the material to remain unmelted on the molten iron 10 for a longer period of time. When the carbon material is small, scatterability within the furnace increases and the material is likely to be drawn into the exhaust gas system, resulting in poor yield. When adopting a lance as the carbon material supplying means, in consideration of transportability and reactivity in the furnace, it is preferable that a carbon material comprising 90% by mass or greater in total of a powder having a particle size of 0.1 mm or more and 3 mm or less be used.

### 1.7.4 Position P₁

As shown in FIG. 4, the position P₁ is a position outside the impingement surface 102x between the oxygen jet stream 21 and the horizontal surface 101x. Preferably, as shown in FIGS. 4 and 5, the carbon material as the auxiliary raw material 31 is supplied to the position P₁ without crossing the oxygen jet stream 21 (in other words, it is preferable that the oxygen jet stream 21 be absent along the path where the carbon material reaches the molten iron 10 from the carbon material supplying means). The “impingement surface 102x between the oxygen jet stream 21 and the horizontal surface 101x” can be specified geometrically from the tilting angle θ₂, spread angle α, height h, and hole diameter d described above. For example, as shown in FIG. 6, a distance r₂ (shown in FIG. 4, distance r₂ from intersection P₃ to a point on the outer edge of impingement surface 102x that intersects with line segment P₂P₃) from the intersection P₃ of the central axis of the oxygen supplying means 20 and the horizontal surface 101x to an outer edge X of the impingement surface 102x can be specified as r₂=(tan θ₂−tan(θ₂−α))h+d/(2 cos θ₂). As shown in FIG. 4, if an angle θ₁ described below is 0° or more and 90° or less and a distance r₃ from the intersection P₃ of the central axis of the oxygen jet stream 21 and the horizontal surface 101x to the position P₁ is larger than the above distance r₂, the position P₁ is always outside the impingement surface 102x. Specifically, in the applied embodiment, the distance r₃ from the intersection P₃ of the central axis of the oxygen jet stream 21 and the horizontal surface 101x to the position P₁ may satisfy the relation r₃>(tan θ₂−tan (θ₂−α))h+d/(2 cos θ₂).

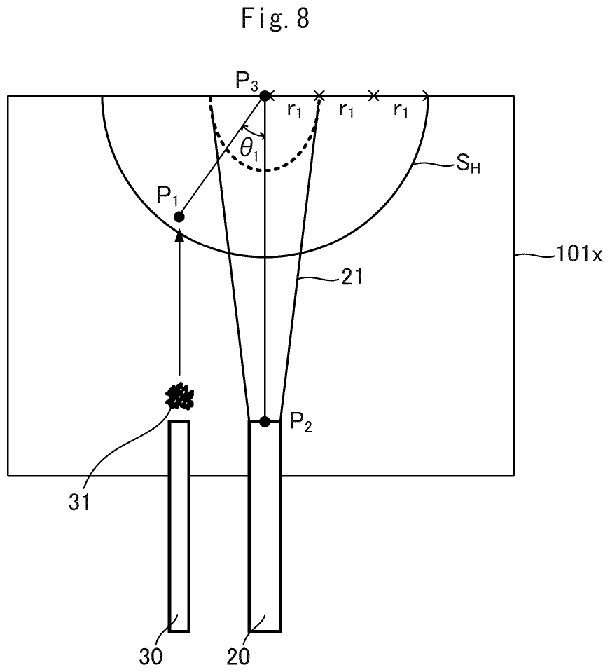

As described above, the position P₁ needs only to be a position outside the impingement surface 102x and forming an angle θ₁, which will be described below, of 0° or more and 90° or less, and the upper limit of the above distance r₃ is not particularly limited. However, it is considered that the closer the position P₁ is to the impingement surface 102x, the more of the carbon material can contribute to the hot spot reaction, and the denitrification efficiency is improved more significantly. According to the findings of the present inventors, when the position P₁ is located inside the semicircle SH shown in FIG. 8, denitrification efficiency is improved more significantly. Specifically, on the horizontal surface 101x, when a semicircle SH having a radius 3r₁ (r₁: minor radius of geometrical hot spot) centered on the intersection P₃ and having the line segment P₂P₃ as an axis of symmetry is assumed, the position P₁ is preferably inside the semicircle SH. In other words, the above distance r₃ is preferably smaller than the radius 3r₁ of the semicircle SH. Note that r₁ is a straight line passing through the intersection P₃ and corresponds to the length from the intersection of a straight line perpendicular to the line segment P₂P₃ and the outer edge of the impingement surface 21x to the intersection P₃. In the same manner as r₂ described above, r₁ can be specified geometrically from the tilting angle θ₂, spread angle α, height h, and hole diameter d.

As described above, when decarburization from the molten iron 10 proceeds due to the oxygen jet stream 21, causing carbon concentration of the molten iron 10 to fall below the critical carbon concentration, consumption rate of carbon in the molten iron 10 by the decarburization reaction exceeds supplying rate of dissolved carbon to the reaction site. Thus, the ratio of oxygen supplied by the oxygen feed that contributes to decarburization (decarburizing oxygen efficiency) gradually decreases and CO generation rate at the hot spot decreases, which can result in a disadvantageous state for denitrification. There is also a risk that Fe in the molten iron 10 becomes excessively oxidized, resulting in a decrease in iron yield, or that FeO concentration in the slag increases, resulting in damage to the refractories of the arc furnace 100. By shortening the distance r₃ relative to the characteristic length calculated based on the weight of the molten iron 10 and thereby increasing the dissolved carbon concentration in the vicinity of the hot spot, it is considered that activity of dissolved [N] increases, denitrification efficiency is further improved, and excessive oxidation of Fe is suppressed. From this viewpoint, the position P₁ where the carbon material is supplied may be determined with reference to the characteristic length of the iron bath determined from the weight of the molten iron 10 in each charge and the value of stirring power density. As described above, since the characteristic flow velocity in the inertial region of the fluid is proportional to the ⅓ power of the stirring power density, if the distance r₃ from the intersection P₃ to the position P₁ is sufficiently short with respect to the characteristic flow velocity, the delay in the supply of the carbon material to the hot spot is further mitigated, a high rate of CO gas generation due to the decarburization reaction is maintained, which is considered advantageous to denitrification. Specifically, for example, with respect to a furnace in which top-blowing stirring and bottom-blowing stirring are dominant, the upper limit of the distance r₃ can be defined such that the following relation is satisfied. Stirring power density is as described above.

$${r}_{3} \leq {( L \cdot {ε}_{a} )}^{1 / 3} / 1.8$$

$$L = {( {W}_{m} / ρ 1 )}^{1 / 3}$$

$${ε}_{a} = ε T + ε B$$

L: characteristic length (m)
εₐ: total stirring power density (W/ton)
Wₘ: weight (ton) of molten iron
ρ₁: density (ton/m³) of molten iron
εT: top-blowing stirring power density (W/ton)
εB: bottom-blowing stirring power density (W/ton)

According to the findings of the present inventors, in the applied embodiment, by satisfying the following relation (1A), movement of the carbon material to the hot spot is less likely to be delayed, leading to an increased carbon concentration in the vicinity of the hot spot, and thereby the intended reaction is more likely to be efficiently produced.

$${r}_{3} \leq 0.7 \times {W}_{m}^{1 \backslash 3} \qquad ( 1 A )$$

r₃: a distance (m) from intersection P₃ to position P₁
Wₘ: a weight (ton) of molten iron 10

### 1.7.5 Angle θ₁

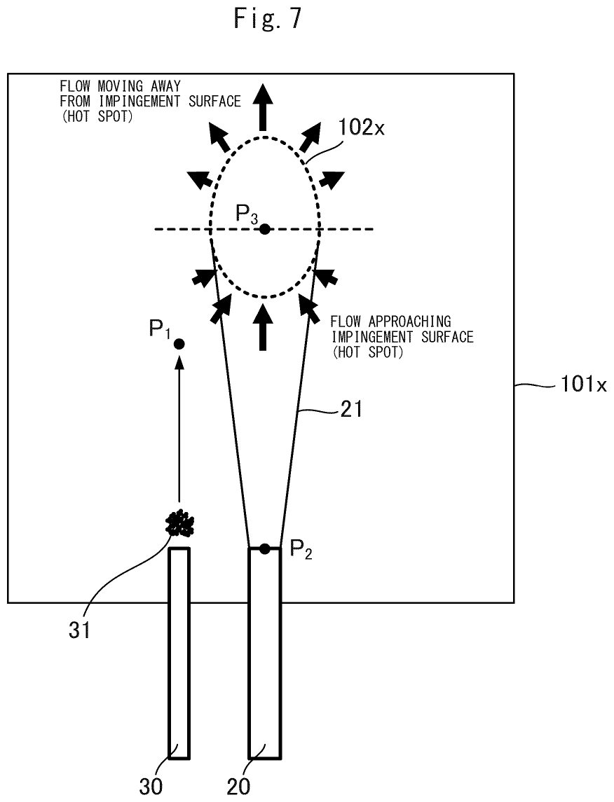

As shown in FIG. 4, in the applied embodiment, the angle θ₁ between the line segment P₁P₃ connecting the position P₁ and the intersection P₃ and the line segment P₂P₃ connecting the intersection P₂ and the intersection P₃ is preferably 0° or more and 90° or less. When the direction of the oxygen jet stream 21 is tilted with respect to the vertical direction, a directional flow is easily induced in the vicinity of the impingement surface 102x of the oxygen jet stream 21. Specifically, as shown in FIG. 7, at a position where the angle θ₁ is more than 90°, a flow moving away from the impingement surface 102x is easily induced, whereas at a position where the angle θ₁ is 0° or more and 90° or less, a flow approaching the impingement surface 102x is easily induced. In the applied embodiment, since the carbon material is supplied toward the position P₁, where the angle θ₁ is 0° or more and 90° or less, the carbon material is supplied upstream of the flow approaching the impingement surface 102x, and the carbon material is efficiently supplied to the hot spot. Specifically, a large portion of the carbon material contributes to the hot spot reaction, and denitrification efficiency is notably improved. Particularly, when the angle θ₁ is 0° or more and less than 90°, 0° or more and 80° or less, 0° or more and 60° or less, 0° or more and 45° or less, or 0° or more and 30° or less, a greater effect is easily obtained.

### 1.7.6 Additional Configurations

In the applied embodiment, additional configurations of the arc furnace 100 and the composition of molten steel are as described above.

### 2. Arc Furnace

The technique of the present disclosure, in addition to an aspect as a manufacturing method for molten steel as described above, also has an aspect as an arc furnace. Specifically, as shown in FIGS. 1 to 3, the arc furnace 100 according to one embodiment processes molten iron 10, and comprises at least one oxygen supplying means 20 and at least one auxiliary raw material supplying means 30. The oxygen supplying means 20 is configured to inject the oxygen jet stream 21 toward a surface 10x of the molten iron 10 within the arc furnace 100. In addition, the auxiliary raw material supplying means 30 is configured to supply an auxiliary raw material 31 toward a position P on a surface 10x of the molten iron 10 within the arc furnace 100, and is configured so that the position P is positioned outside an impingement surface between the oxygen jet stream 21 and the iron molten 10. Details of the oxygen supplying means 20 and auxiliary raw material supplying means 30 are as described above. The oxygen supplying means 20 and auxiliary raw material supplying means 30 may be controlled by, for example, the above control unit. Specifically, the arc furnace 100 according to one embodiment may further comprise a control unit, wherein the control unit may control one or both of the oxygen supplying means 20 and the auxiliary raw material supplying means so that the oxygen supplying means 20 injects an oxygen jet stream 21 to the molten iron 10 within the arc furnace 100 and the auxiliary raw material supplying means 30 supplies an auxiliary raw material 31 toward a predetermined position P on a surface of the molten iron 10.

As described above, in the arc furnace 100, the auxiliary raw material supplying means 30 may comprise at least one carbon material supplying means; the oxygen supplying means 20 may be configured so that the direction of the oxygen jet stream 21 is tilted with respect to the vertical direction; the carbon material supplying means may be configured so that the carbon material is supplied toward the position P₁; and the oxygen supplying means 20 and the carbon material supplying means may be configured so that
the position P₁ is on the horizontal surface 101x including a static molten iron surface,
the position P₁ is outside the impingement surface 102x between the oxygen jet stream 21 and the horizontal surface 101x,
a perpendicular line dropped from the tip of the oxygen supplying means 20 to the horizontal surface 101x intersects with the horizontal surface 101x at the intersection P₂,
the central axis of the oxygen jet stream 21 intersects with the horizontal surface 101x at the intersection P₃, and
the angle θ₁ between the line segment P₁P₃ connecting the position P₁ and the intersection P₃ and the line segment P₂P₃ connecting the intersection P₂ and the intersection P₃ is 0° or more and 90° or less.

### 3. Action and Effect

Hereinafter, the action and effect of the manufacturing method for molten steel of the present disclosure will be further supplemented, with a focus on the case where a carbon material as the auxiliary raw material 31 is adopted.

As described above, when a carbon material is adopted as the auxiliary raw material, oxygen-fed decarburization and denitrification reactions can be produced. The general factors governing the rate of nitrogen adsorption/desorption during oxygen-fed decarburization are considered to include at least
(1) CO generation rate at the hot spot
(2) temperature of C—O reaction site at the hot spot
(3) gas-liquid reaction interface area between CO bubbles and molten iron.
   Additional factors include the air entrained by the oxygen jet stream (soft blowing increases amount of air drawn to the hot spot) and the concentrations of surface-active components in the molten iron (when [S] and [O] are high, reaction rate decreases).

In the prior art, mainly for the purpose of promoting slag foaming, simultaneous blowing of oxygen jet stream and carbon material in an arc furnace has been practiced, and in this case, both are blown to the same position on the molten iron surface. Specifically, by merging the carbon material into the oxygen jet stream and concentratedly supplying carbon and oxygen to a single site of the molten iron, CO gas is reliably generated in the slag and a foaming state of the slag is stabilized. However, when a carbon material and oxygen are blown to the same position on the molten iron surface, from the viewpoint of nitrogen adsorption/desorption reactions,
(1) since C—O reaction sites become dispersed not only at the hot spot but also into the slag or into the air, CO generation rate at the hot spot decreases,
(2) since a carbon material near room temperature is charged directly to the hot spot, the temperature of C—O reaction sites at the hot spot decreases, and
(3) since C—O reaction sites become dispersed not only at the hot spot but also into the slag or into the air, the decarburization amount from the molten iron decreases, and the gas-liquid reaction interface area between CO bubbles and molten iron also decreases. As described above, the method of the prior art leads to a decrease in denitrification reaction rate.

According to the manufacturing method for molten steel of the present disclosure, when the oxygen jet stream 21 is injected to the molten iron 10, by supplying a carbon material as the auxiliary raw material 31 toward the position P (alternatively, position P₁) outside the impingement surface between the oxygen jet stream 21 and the molten iron 10 (i.e., outside the hot spot area),
(1) C—O reaction sites are concentrated at the hot spot, and CO generation rate in the hot spot increases,
(2) a carbon material near room temperature is charged outside the hot spot area to suppress a decrease in temperature of the C—O reaction sites at the hot spot, and
(3) C—O reaction sites are concentrated at the hot spot, the decarburization amount from the molten iron increases, and the gas-liquid reaction interface area between CO bubbles and molten iron 10 increases. As a result, it is considered that denitrification reaction rate can be increased. Particularly, by supplying a carbon material toward the position P₁ outside the impingement surface 102x of the oxygen jet stream 21 (i.e., outside the hot spot) and upstream of the flow approaching the impingement surface 102x (i.e. flow approaching the hot spot), it is considered that the denitrification reaction rate can be notably increased.

The effect in which a decrease in hot spot temperature can be suppressed is exhibited regardless of the type of auxiliary raw material 31. Specifically, according to the manufacturing method of the present disclosure, regardless of the type of auxiliary raw material 31, the amount of auxiliary raw material 31 supplied directly to the hot spot can be decreased, the temperature of the hot spot is not likely to decrease, and the intended reaction can be efficiently produced.

### EXAMPLES

Hereinafter, the present invention will be further described with reference to the Examples. However, the present invention is not limited to the following Examples. The present invention, as long as the object thereof is achieved without departing from the spirit thereof, allows various conditions to be adopted.

### 1. Examination 1

### 1.1 Manufacturing Conditions of Molten Steel

In the present Examples, in an arc furnace having the following configurations (1) to (6), smelting of molten steel was carried out using scrap as the cold iron source.
(1) The furnace shell diameter of the melting furnace was 7 m.
(2) The maximum molten iron weight that can be processed at once was 200 t.
(3) The arc furnace used a three-phase alternating current system with three upper graphite electrodes.
(4) Two oxygen supplying wall lances and two powder supplying wall lances were provided so as to be fixed to a furnace wall.
(5) A manipulator (movable-type arm) insertable from the furnace exterior into the furnace interior was provided, and the manipulator was provided with a variable oxygen supplying lance and a variable powder supplying lance.
(6) The furnace bottom was provided with a bottom-blowing tuyere at three locations.

In the present Examples, a conventional arc furnace operating method was adopted. Supplying of oxygen and supplying of auxiliary raw material were each carried out from one location, the supplying rates being 1,000 to 4,000 Nm³/h and 0.01 to 0.10 t/min, respectively. The lances used, the supplying positions of the auxiliary raw material, and the ranges of supplying rates were appropriately changed.

Specifically, in each charge, after visually confirming through the slag removal port on a furnace body side portion that the entirety of the cold iron source charged had melted, a carbon material as the auxiliary raw material was supplied by a fixed-type powder lance installed on the furnace interior wall, and oxygen gas was simultaneously supplied from a movable-type oxygen supplying lance inserted into the furnace through the slag removal port. The area of the hot spot was determined geometrically from the relationship shown in FIG. 3, and the charging position and blowing angle of the movable-type oxygen supplying lance was successively adjusted so that the difference Ar between the distance r from the intersection O of the central axis of the oxygen supplying lance and the surface of the molten iron to the target supplying position P of the auxiliary raw material and the distance z from the intersection O to the outer edge of the hot spot area was a predetermined value. When Ar was positive, the target supplying position P was outside the hot spot area, and when negative, the target supplying position P was inside the hot spot area. In the present Examples, the smaller the Ar, the more the movable lance needed to be tilted (angle θ needed to be increased), and as a result, the distance z tended to increase. In addition, the smaller the molten iron weight, the lower the molten surface, and the height h tended to increase and the distance z tended to increase. Samples were taken before and after the start of oxygen supplying and carbon supplying and subjected to chemical analysis. The superiority or inferiority of each level based on the nitrogen concentration change A [N] within the same charge obtained through the analysis was evaluated. Evaluation criteria were as follows.

$$A : Δ [ N ] \leq - 30 ppm$$

$$B : - 30 ppm < Δ [ N ] \leq - 20 ppm$$

$$C : - 20 ppm < Δ [ N ] \leq - 10 ppm$$

$$D : - 10 ppm < Δ [ N ]$$

### 1.2 Evaluation Results

In Table 1 below, test conditions and evaluation results according to A [N] for each of the Examples and Comparative Examples are shown. Note that in Table 1 below, “Distance A” is a value determined by the formula below in which the weight Wₘ (t) of the molten iron was used.

$$Distance A = 0.7 \times {W}_{m}^{\frac{1}{3}}$$

TABLE 1

| | | | Auxiliary | Molten | | | |
|---|---|---|---|---|---|---|---|
| | | | raw | iron | Distance | | |
| | z | Δr | material | weight | A | Δ[N] | Evaluation |
| | (m) | (m) | type | (t) | (m) | (ppm) | result |
| Example 1 | 0.20 | 0.10 | lime | 180 | 3.95 | −10 | C |
| Example 2 | 0.20 | 0.20 | lime | 180 | 3.95 | −11 | C |
| Comparative | 0.20 | −0.10 | lime | 180 | 3.95 | −3 | D |
| Example 1 | | | | | | | |
| Comparative | 0.20 | −0.20 | lime | 180 | 3.95 | +8 | D |
| Example 2 | | | | | | | |
| Comparative | 0.20 | −0.10 | Carbon | 180 | 3.95 | −7 | D |
| Example 3 | | | material | | | | |
| Example 3 | 0.20 | 0.10 | Carbon | 180 | 3.95 | −35 | A |
| | | | material | | | | |
| Example 4 | 0.20 | 0.20 | Carbon | 180 | 3.95 | −37 | A |
| | | | material | | | | |
| Example 5 | 0.19 | 1.00 | Carbon | 180 | 3.95 | −32 | A |
| | | | material | | | | |
| Example 6 | 0.17 | 2.00 | Carbon | 180 | 3.95 | −32 | A |
| | | | material | | | | |
| Example 7 | 0.15 | 3.00 | Carbon | 180 | 3.95 | −35 | A |
| | | | material | | | | |
| Example 8 | 0.13 | 3.50 | Carbon | 180 | 3.95 | −31 | A |
| | | | material | | | | |
| Example 9 | 0.12 | 4.00 | Carbon | 180 | 3.95 | −20 | B |
| | | | material | | | | |
| Example 10 | 0.10 | 4.50 | Carbon | 180 | 3.95 | −11 | C |
| | | | material | | | | |
| Example 11 | 0.24 | 1.00 | Carbon | 120 | 3.45 | −31 | A |
| | | | material | | | | |
| Example 12 | 0.19 | 2.00 | Carbon | 120 | 3.45 | −33 | A |
| | | | material | | | | |
| Example 13 | 0.16 | 3.00 | Carbon | 120 | 3.45 | −30 | A |
| | | | material | | | | |
| Example 14 | 0.13 | 3.50 | Carbon | 120 | 3.45 | −27 | B |
| | | | material | | | | |
| Example 15 | 0.11 | 4.00 | Carbon | 120 | 3.45 | −13 | C |
| | | | material | | | | |
| Example 16 | 0.10 | 4.50 | Carbon | 120 | 3.45 | −11 | C |
| | | | material | | | | |

In the present Examples and Comparative Examples, auxiliary raw materials were blown from the fixed-type wall lance and oxygen was fed from the movable-type lance inserted from the slag removal port. However, even when oxygen was fed from the wall lance and auxiliary raw materials were supplied from the movable-type lance for each level, no significant difference was observed in Δ[N], and results similar to those in Table 1 above were shown. The amount of molten iron was changed by adjusting the amount of the cold iron source charged. In that case, the arrangement of the refractories was changed so that the geometrical positional relationship between the fixed-type wall lance and the molten surface did not change.

At each level, results of the first sampling were [C]=0.48 to 0.52%, results of the second sampling were [C]=0.04 to 0.06%, and decarburization amount derived from the iron bath was substantially the same. Regarding [N], results of the first sampling were [N]=0.0070 to 0.0075%. When a carbon material as the auxiliary raw material was sprayed, the carbon source was continuously supplied from the outside, and thus the desired effect was exhibited regardless of the amount of carbon derived from the iron bath. In Examples 1 and 2 and Comparative Examples 1 and 2, since a material other than a carbon material was used as the auxiliary raw material, it is considered that only the decarburization reaction derived from the iron bath contributed to denitrification.

From the results shown in Table 1, it can be said that in the arc furnace, when an oxygen jet stream is injected from the oxygen supplying means to the molten iron within the furnace and an auxiliary raw material is supplied from the auxiliary raw material supplying means toward the position P on the surface of the molten iron, molten steel having a lower nitrogen concentration can be manufactured when the position P is outside the hot spot area, i.e., outside the impingement surface between the oxygen jet stream and the molten iron (Examples 1 to 16), than when inside (Comparative Examples 1 to 3). In addition, from a comparison between Examples 1 and 2 and Examples 3 to 16, it can be said that when the auxiliary raw material is a carbon material, molten steel having a lower nitrogen concentration can be manufactured. Further, from the results of Examples 3 to 16, it can be said that when the following relation (1) is satisfied, molten steel having an even lower nitrogen concentration can be manufactured.

$$r \leq 0.7 \times {W}_{m}^{\frac{1}{3}} \qquad ( 1 )$$

wherein
r is a distance (m) from an intersection O of a central axis of the oxygen jet stream and a surface of the molten iron to the above position P, and
Wₘ is a weight (t) of the molten iron.

### 2. Examination 2

### 2.1 Manufacturing Conditions of Molten Steel

In the arc furnace having the following configurations (1) to (7), smelting of molten steel was carried out using scrap as the cold iron source.
(1) The furnace shell diameter of the melting furnace was 7 m.
(2) The maximum molten iron weight that can be processed at once was 200 tons.
(3) The arc furnace used a three-phase alternating current system with three upper graphite electrodes.
(4) Two oxygen supplying wall lances and two powder supplying wall lances were provided so as to be fixed to a furnace wall.
(5) A manipulator (movable-type arm) insertable from the furnace exterior into the furnace interior was provided, and the manipulator was provided with a variable oxygen supplying lance and a variable powder supplying lance.
(6) The furnace bottom was provided with a bottom-blowing tuyere at three locations.
(7) An auxiliary raw material chute was provided on the furnace cover.

Operation of the arc furnace was carried out according to a conventional method. Supplying of oxygen and supplying of carbon material were each carried out from one location, the supplying rates being 1,000 to 4,000 Nm³/h and 10 to 100 kg/min, respectively. The lances used, the supplying position of the carbon material, and the ranges of supplying rates were appropriately changed.

In each charge, it was confirmed through the slag removal port on a side portion of the furnace body that the entirety of the cold iron source charged was melted, and a 180-ton iron bath was formed. An oxygen jet stream was then injected toward the iron bath by a variable oxygen supplying lance inserted into the furnace through the slag removal port or a fixed-type oxygen supplying wall lance installed on a furnace interior wall, and a carbon material was charged to the target supplying position P₁ within the furnace by a movable-type or fixed-type lance or a chute provided on the furnace cover. The injection direction of a fixed lance was changed by adjustment before the start of processing. The area of the hot spot was determined geometrically, and the blowing angle was appropriately adjusted so that the horizontal distance r₃ from the intersection P₃ of the central axis of the oxygen supplying lance and the horizontal surface including the static molten iron surface to the target supplying position P₁ of the carbon material was a predetermined value. The supplying of oxygen and supplying of carbon material were each carried out for 10 min, and before the start of supplying and after the end of supplying of oxygen and carbon material, the molten iron was sampled and subjected to chemical analysis. The superiority or inferiority of each level based on the nitrogen concentration change A [N] within the same charge obtained through the analysis was evaluated. Evaluation criteria were as follows.

$$A : Δ [ N ] \leq - 30 ppm$$

$$B : - 30 ppm < Δ [ N ] \leq - 15 ppm$$

$$C : - 15 ppm < Δ [ N ] \leq - 5 ppm$$

$$D : - 5 ppm < Δ [ N ]$$

In the present Examples and Comparative Examples, the carbon material was supplied by charging via an auxiliary raw material chute provided on the furnace cover or by injecting through a carrier gas from a lance. However, no significant difference could be confirmed in Δ[N] even when the supplying equipment used for each level was changed.

### 2.2 Evaluation Results

In Table 2 below, test conditions and evaluation results according to A [N] for each of the Examples and Comparative Example are shown.

In Table 2 below, “Height h₁ (mm)” corresponds to h₁ shown in FIG. 6, i.e., the height from the tip (lower end) of the lance to the static molten iron surface (horizontal surface 101x).

In Table 2 below, “Angle θ₂(°)” corresponds to θ₂ shown in FIG. 6, i.e., the angle between the central axis of the lance and a line parallel to the vertical direction.

In Table 2 below, “r₁ (mm)” corresponds to r₁ shown in FIG. 4, i.e., the length from the intersection of a straight line that passes through the intersection P₃ and is perpendicular to the line segment P₂P₃ and the outer edge of the impingement surface 102x to the intersection P₃. “3r₁ (mm)” is a value three times of r₁.

In Table 2 below, “r₂ (mm)” corresponds to r₂ shown in FIG. 4, i.e., the distance from the intersection P₃ of the central axis of the lance and the static molten iron surface (horizontal surface 101x) to a point intersecting with the line segment P₂P₃, which is a point on the outer edge of the impingement surface 102x of the oxygen jet stream 21.

In Table 2 below, “r₃ (mm)” corresponds to r₃ shown in FIG. 4, i.e., the distance from the intersection P₃ to the position P₁, as described above. When r₃ is larger than r₁, the position P₁ is always outside the hot spot, whereas when r₃ is smaller than r₁, the position P₁ can be inside the hot spot. In addition, when r₃ is larger than 3r₁, the position P₁ is outside the semicircle SH shown in FIG. 6, whereas when r₃ is smaller than 3r₁, the position P₁ is contained inside the semicircle SH shown in FIG. 6.

In Table 2 below, “Angle θ₁ (°)” corresponds to θ₁ shown in FIG. 4, i.e., the angle between the line segment P₁P₃ connecting the position P₁ to the intersection P₃ and the line segment P₂P₃ connecting the intersection P₂ to the intersection P₃.

The following was found from the results shown in Table 2.

TABLE 2

| | Height | Angle | | | | Angle | | |
|---|---|---|---|---|---|---|---|---|
| | h | θ₂ | 3r₁ | r₂ | r₃ | θ₁ | Δ[N] | |
| | (mm) | (°) | (mm) | (mm) | (mm) | (°) | (ppm) | Evaluation |
| Comparative | 500 | 45 | 374 | 200 | 100 | 0 | −3 | D |
| Example 1A | | | | | (within | | | |
| | | | | | hot | | | |
| | | | | | spot) | | | |
| Example 1A | 500 | 45 | 374 | 200 | 300 | 120 | −12 | C |
| Example 2A | 500 | 45 | 374 | 200 | 300 | 60 | −28 | B |
| Example 3A | 500 | 45 | 374 | 200 | 500 | 30 | −16 | B |
| Example 4A | 500 | 45 | 374 | 200 | 300 | 30 | −26 | B |
| Example 5A | 500 | 45 | 374 | 200 | 300 | 0 | −33 | A |

Comparative Example 1A is an example in which a carbon material was supplied into the hot spot. In this case, A [N] was-3 ppm and sufficient denitrification could not be carried out. In Comparative Example 1A, it is considered that, by supplying the carbon material into the hot spot, (1) C—O reaction sites became dispersed not only at the hot spot but also into the slag or into the air, and thus CO generation rate decreased; (2) the carbon material, which was near room temperature, was charged directly into the hot spot, and thus the temperature of C—O reactions sites at the hot spot decreased; and (3) the C—O reaction sites became dispersed not only at the hot spot but also into the slag or into the air, and thus the decarburization amount from the molten iron decreased and the gas-liquid reaction interface area between the CO bubbles and molten iron decreased.

Example 1A is an example in which a carbon material was supplied outside the hot spot. In this case, Δ[N] was −12 ppm and denitrification efficiency was improved compared to Comparative Example 1A. In Example 1A, it is considered that, by supplying the carbon material outside the hot spot, (1) C—O reaction sites were concentrated at the hot spot, and CO generation rate at the hot spot increased; (2) the carbon material, which was near room temperature, was charged outside the hot spot area, and a decrease in temperature of the C—O reaction sites at the hot spot was suppressed; and (3) the C—O reaction sites were concentrated at the hot spot, the decarburization amount from the molten iron increased, and the gas-liquid reaction interface area between the CO bubbles and the molten iron increased.

Examples 2A to 5A are examples in which a carbon material was supplied toward a target position P₁ outside the hot spot and where angle θ₁ was 90° or less. In this case, A [N] was −15 ppm or less, and denitrification efficiency was further improved compared to Example 1A. In Examples 2A to 5A, it is considered that a flow approaching the hot spot was generated at target position P₁ where the carbon material was supplied (refer to FIG. 7), and it is considered that the carbon material was efficiently supplied to the hot spot. As a result, it is considered that in Examples 2A to 5A, the C—O reaction sites were further concentrated at the hot spot, CO generation rate at the hot spot was further increased, the decarburization amount from the molten iron was further increased, and the gas-liquid reaction interface area between CO bubbles and molten iron was further increased.

From the results of Examples 2A to 5A, when manufacturing molten steel using an arc furnace, if
condition A: direction of an oxygen jet stream is tilted with respect to a vertical direction;
condition B: position P₁ is outside an impingement surface between the oxygen jet stream and the horizontal surface; and
condition C: angle θ₁ between a line segment P₁P₃ connecting the position P₁ to an intersection P₃ and a line segment P₂P₃ connecting an intersection P₂ to the intersection P₃ is 0° or more and 90° or less
   are satisfied, it can be said that the denitrification efficiency in the molten iron is further notably improved.

From the results of Examples 2A to 5A, in addition to the above conditions A to C, if
condition D: a semicircle SH having a radius 3r₁ (r₁: minor radius of geometrical hot spot) centered on the intersection P₃ and having the line segment P₂P₃ as an axis of symmetry is assumed, the position P₁ is inside the semicircle SH is satisfied, it can be said that the denitrification efficiency in the molten iron is further notably improved.

The above Examples 1A to 5A and Comparative Example 1A show examples each having predetermined values for the height h₁, angle θ₂, r₁, and r₂. However, the height h₁, angle θ₂, r₁, and r₂ do not substantially affect the above action and effect. Specifically, even if the height h₁, angle θ₂, r₁, and r₂ were different from those in the above examples, it can be said that by satisfying the above conditions A to C (preferably the above conditions A to D), the same denitrification efficiency improvement is obtained. In addition, the above Examples 1A to 5A and Comparative Example 1A show examples in which scrap was used as the cold iron source. However, the type of cold iron source is not particularly limited. When manufacturing molten steel using an arc furnace, even when a cold iron source other than scrap (for example, reduced iron, pig iron, or granular iron) is used, it can be said that by satisfying the above conditions A to C (preferably the above conditions A to D), the same denitrification efficiency improvement effect is obtained.

### REFERENCE SIGNS LIST

100 arc furnace
10 molten steel
   10x surface of molten iron (molten surface)
20 oxygen supplying means
   21 oxygen jet stream
   21x impingement surface
30 auxiliary raw material supplying means
   31 auxiliary raw material
40 upper electrode
50 lower electrode
60 iron source charging means
70 slag removal door
80 taphole
101x horizontal surface
102x impingement surface

1. A manufacturing method for molten steel using an arc furnace comprising an oxygen supplier and an auxiliary raw material supplier, the method comprising:
injecting an oxygen jet stream from the oxygen supplier to molten iron within the arc furnace; and supplying an auxiliary raw material from the auxiliary raw material supplier toward a position P on a surface of the molten iron, wherein
the position P is a position outside an impingement surface between the oxygen jet stream and the molten iron.

2. The manufacturing method for molten steel according to claim 1, wherein
the auxiliary raw material is a carbon material.

3. The manufacturing method for molten steel according to claim 1, wherein
a relation (1) below is satisfied:
$$r \leq 0.7 \times {W}_{m}^{\frac{1}{3}} \qquad ( 1 )$$
wherein
r is a distance (m) from an intersection O of a central axis of the oxygen jet stream and a surface of the molten iron to the position P, and
Wₘ is a weight (t) of the molten iron.

4. The manufacturing method for molten steel according to claim 1, the method comprising:
injecting the oxygen jet stream from the oxygen supplier to molten iron within the arc furnace; and supplying a carbon material from a carbon material supplier as the auxiliary raw material supplier toward a position P₁, wherein
a direction of the oxygen jet stream is tilted with respect to a vertical direction,
the position P₁ is on a horizontal surface including a static molten iron surface,
the position P₁ is outside the impingement surface between the oxygen jet stream and the molten iron,
a perpendicular line dropped from a tip of the oxygen supplier to the horizontal surface intersects with the horizontal surface at an intersection P₂,
a central axis of the oxygen jet stream intersects with the horizontal surface at an intersection P₃, and
an angle θ₁ between a line segment P₁P₃ connecting the position P₁ to the intersection P₃ and a line segment P₂P₃ connecting the intersection P₂ to the intersection P₃ is 0° or more and 90° or less.

5. The manufacturing method for molten steel according to claim 4, wherein
on the horizontal surface, when a semicircle having a radius 3r₁ (r₁: minor radius of geometrical hot spot) centered on the intersection P₃ and having the line segment P₂P₃ as an axis of symmetry is assumed, the position P₁ is inside the semicircle.

6. An arc furnace for processing molten iron, comprising at least one oxygen supplier and at least one auxiliary raw material supplier, wherein
the oxygen supplier is configured to inject an oxygen jet stream toward a surface of the molten iron within the arc furnace, and
the auxiliary raw material supplier is configured to supply an auxiliary raw material toward a position P on a surface of the molten iron within the arc furnace, and is configured so that the position P is positioned outside an impingement surface between the oxygen jet stream and the molten iron.

7. The arc furnace according to claim 6, wherein
the auxiliary raw material supplier comprises at least one carbon material supplying means,
the oxygen supplier is configured so that a direction of the oxygen jet stream is tilted with respect to a vertical direction,
the carbon material supplier is configured to supply a carbon material toward a position P₁, and
the oxygen supplier and the carbon material supplier are configured so that:
the position P₁ is on a horizontal surface including a static molten iron surface;
the position P₁ is outside the impingement surface between the oxygen jet stream and the horizontal surface;
a perpendicular line dropped from a tip of the oxygen supplier to the horizontal surface intersects with the horizontal surface at an intersection P₂;
a central axis of the oxygen jet stream intersects with the horizontal surface at an intersection P₃; and
an angle θ₁ between a line segment P₁P₃ connecting the position P₁ to the intersection P₃ and a line segment P₂P₃ connecting the intersection P₂ to the intersection P₃ is 0° or more and 90° or less.
